(19) United States
(12) Patent Application Publication
(10) Pub. No.: US 2018/0191580 A1
(43) Pub. Date: Jul. 5, 2018

(54) METHOD AND APPARATUS FOR ON-BOARDING NETWORK SERVICE DESCRIPTOR

(71) Applicant: Huawei Technologies Co., Ltd., Shenzhen (CN)

(72) Inventors: Haitao Xia, Beijing (CN); Fang Yu, Beijing (CN); Jianning Liu, Beijing (CN); Xu Yang, Beijing (CN)

(21) Appl. No.: 15/906,178

(22) Filed: Feb. 27, 2018

Related U.S. Application Data
(63) Continuation of application No. PCT/CN2015/088607, filed on Aug. 31, 2015.

(51) Int. Cl. H04L 12/24

(52) U.S. Cl. CPC H04L 41/5041

(57) ABSTRACT

The present disclosure discloses a method and an apparatus for on-boarding network service descriptor. The method includes: receiving, by a primary orchestrator, a cross-domain network service descriptor NSD on-boarding command from a sender; determining according to the cross-domain NSD on-boarding command, that a secondary orchestrator needs to on-board an NSD corresponding to a management domain of the secondary orchestrator; and sending, an NSD on-boarding command to the secondary orchestrator, where the NSD on-boarding command is used to instruct the secondary orchestrator to on-board the NSD corresponding to the management domain of the secondary orchestrator, and a management domain of the primary orchestrator is different from the management domain of the secondary orchestrator. The method or the apparatus of the present disclosure can ensure consistency and reliability of an NSD on-boarding process in a scenario of NS deployment across NFVO management domains.

### CROSS-REFERENCE TO RELATED APPLICATIONS

This application is a continuation of International Patent Application No. PCT/CN2015/088607 filed on Aug. 31, 2015. The disclosure of the aforementioned application is hereby incorporated by reference in the entity.

### TECHNICAL FIELD

The present disclosure relates to the field of network communications technologies, and in particular, to a method and an apparatus for on-boarding a network service descriptor.

### BACKGROUND

Network Function Virtualization (NFV) is a technology in which a telecommunication network operator implements some of telecommunication network functions by using a general server, router, and memory with reference to a network virtualization technology in the field of Internet technology (IT). To implement the technology, the telecommunication network functions need to be implemented in a software manner. Software and hardware are decoupled, and the functions can run on hardware such as the general server, router, and memory. Meanwhile, operations such as instantiation, flexible scaling, and migration of a network service (NS) or a virtualized network function (VNF) are automatically performed as required.

An existing NFV system includes a VNF, an NFV infrastructure (NFVI), and management and orchestration (MANO). The MANO includes a virtualized infrastructure manager (VIM), an NFV orchestrator (NFVO), and a VNF manager (VNFM). The NFVO is responsible for life cycle management on an NS, and orchestrates and manages virtualized resources (including a hardware resource and a software resource) of the entire NFV system.

A process of on-boarding a network service descriptor (NSD) means registering the NS in a network service catalog (NS Catalog), to ensure that the NSD and VNF packet information forming the NS are available in the catalog. By means of research, it is found that, the method for on-boarding an NSD in the prior art is suitable only for NS deployment in a single NFVO management domain, or in other words, NS deployment in a same NFVO management domain.

### SUMMARY

In view of this, the present disclosure provides a method and an apparatus for on-boarding a network service descriptor, so as to be applicable to NS deployment across NFVO management domains. Specific solutions thereof are as follows:

According to a first possible implementation of a first aspect of this application, this application provides a method for on-boarding a network service descriptor, including:

receiving, by a primary orchestrator, a cross-domain network service descriptor NSD on-boarding command from a sender;

determining, by the primary orchestrator according to the cross-domain NSD on-boarding command, that a secondary orchestrator needs to on-board an NSD corresponding to a management domain of the secondary orchestrator; and

sending, by the primary orchestrator, an NSD on-boarding command to the secondary orchestrator, where the NSD on-boarding command is used to instruct the secondary orchestrator to on-board the NSD corresponding to the management domain of the secondary orchestrator, where

a management domain of the primary orchestrator is different from the management domain of the secondary orchestrator.

With reference to a second possible implementation of the first aspect, the method further includes:

determining, according to the cross-domain NSD on-boarding command, that the primary orchestrator needs to on-board an NSD corresponding to the management domain of the primary orchestrator.

With reference to a third possible implementation of the first aspect, the cross-domain NSD on-boarding command carries NSD information for describing a network service NS and virtualized network function VNF packet information; and

the determining, according to the cross-domain NSD on-boarding command, that the primary orchestrator needs to on-board an NSD corresponding to the management domain of the primary orchestrator specifically includes:

determining, according to the cross-domain NSD on-boarding command, the NSD information and the VNF packet information that correspond to the management domain of the primary orchestrator.

With reference to a fourth possible implementation of the first aspect, the determining, according to the cross-domain NSD on-boarding command, that a secondary orchestrator needs to on-board an NSD corresponding to a management domain of the secondary orchestrator specifically includes:

determining, according to the cross-domain NSD on-boarding command, NSD information and VNF packet information that correspond to the management domain of the secondary orchestrator; and

the sending an NSD on-boarding command to the secondary orchestrator specifically includes:

sending, to the secondary orchestrator, the NSD on-boarding command carrying the NSD information and the VNF packet information that correspond to the management domain of the secondary orchestrator.

With reference to a fifth possible implementation of the first aspect, the determining, from the cross-domain NSD on-boarding command, NSD information and VNF packet information that correspond to the management domain of the secondary orchestrator includes:

determining, according to the cross-domain NSD on-boarding command, an NSD identifier and/or a VNF packet identifier that correspond/corresponds to the management domain of the secondary orchestrator; or

determining, according to the cross-domain NSD on-boarding command, an NSD identifier used to describe the NS, an identifier of the primary orchestrator, a correspondence between an identifier used to describe a VNF packet of the NS and the identifier of the primary orchestrator, and/or a correspondence between the identifier used to describe the VNF packet of the NS and an identifier of the secondary orchestrator.

With reference to a sixth possible implementation of the first aspect, after the sending an NSD on-boarding command to the secondary orchestrator, the method further includes

receiving an NSD on-boarding complete notification message fed back by the secondary orchestrator; and

after an NSD corresponding to the management domain of the primary orchestrator is on-boarded, sending a cross-domain NSD on-boarding complete notification message to the sender.

With reference to a seventh possible implementation of the first aspect, the primary orchestrator is a network function virtualization orchestrator or a network service orchestrator, and the secondary orchestrator is a network function virtualization orchestrator or a network service orchestrator.

According to a first possible implementation of a second aspect of this application, this application provides another method for on-boarding a network service descriptor, including:

receiving an NSD on-boarding command sent by a primary orchestrator, where the NSD on-boarding command is used to instruct a secondary orchestrator to on-board an NSD corresponding to a management domain of the secondary orchestrator; and

on-boarding, according to the NSD on-boarding command, the NSD corresponding to the management domain of the secondary orchestrator, where

a management domain of the primary orchestrator is different from the management domain of the secondary orchestrator.

With reference to a second possible implementation of the second aspect, the method further includes:

after the NSD corresponding to the management domain of the secondary orchestrator is on-boarded, feeding back an NSD on-boarding complete notification message to the primary orchestrator.

With reference to a third possible implementation of the second aspect, the primary orchestrator is a network function virtualization orchestrator or a network service orchestrator, and the secondary orchestrator is a network function virtualization orchestrator or a network service orchestrator.

According to a first possible implementation of a third aspect of this application, this application provides a method for on-boarding a network service descriptor, including:

receiving, by a primary orchestrator, a cross-domain network service descriptor NSD on-boarding command from a sender;

determining, by the primary orchestrator according to the cross-domain NSD on-boarding command, that the primary orchestrator needs to on-board an NSD;

in a process of on-boarding the NSD by the primary orchestrator, determining, by the primary orchestrator according to the cross-domain NSD on-boarding command, that a secondary orchestrator needs to verify VNF packet information corresponding to a management domain of the secondary orchestrator;

sending, by the primary orchestrator, a verification command to the secondary orchestrator, where the verification command is used to instruct the secondary orchestrator to verify whether the VNF packet information is available, and the verification command includes the VNF packet information; and

receiving, by the primary orchestrator, a notification message indicating that the VNF packet information is available, where the notification message is fed back when the secondary orchestrator verifies that the VNF packet information is available, where

a management domain of the primary orchestrator is different from the management domain of the secondary orchestrator.

With reference to a second possible implementation of the third aspect, the cross-domain NSD on-boarding command carries NSD information for describing a network service NS and the VNF packet information, and the determining, according to the cross-domain NSD on-boarding command, that the primary orchestrator needs to on-board an NSD specifically includes:

determining, according to the cross-domain NSD on-boarding command, the NSD information and the VNF packet information corresponding to the management domain of the primary orchestrator that are used to describe the NS.

With reference to a third possible implementation of the third aspect, the determining, according to the cross-domain NSD on-boarding command, that a secondary orchestrator needs to verify VNF packet information corresponding to a management domain of the secondary orchestrator specifically includes:

determining, according to the cross-domain NSD on-boarding command, a VNF packet identifier corresponding to the management domain of the secondary orchestrator; and

the sending a verification command to the secondary orchestrator specifically includes:

sending, to the secondary orchestrator, the verification command carrying the VNF packet identifier corresponding to the management domain of the secondary orchestrator, where the verification command carrying the VNF packet identifier corresponding to the management domain of the secondary orchestrator is used to instruct the secondary orchestrator to verify, according to the VNF packet identifier corresponding to the management domain of the secondary orchestrator, whether a VNF packet and an external interface in the management domain of the secondary orchestrator are available; and

receiving, by the primary orchestrator, a notification message indicating that the VNF packet information is available, where the notification message is fed back when the secondary orchestrator verifies that the VNF packet and the external interface in the management domain of the secondary orchestrator are available; or

receiving, by the primary orchestrator, a verification reply command indicating that the VNF packet information is unavailable, where the verification reply command is fed back when the secondary orchestrator verifies that the VNF packet and the external interface in the management domain of the secondary orchestrator are unavailable.

With reference to a fourth possible implementation of the third aspect, after the sending a verification command to the secondary orchestrator, the method further includes:

receiving a VNF packet on-board acknowledge command that carries a success indication and that is fed back by the secondary orchestrator; and

after the NSD corresponding to the management domain of the primary orchestrator is on-boarded, sending a cross-domain NSD on-boarding complete notification message to the sender.

With reference to a fifth possible implementation of the third aspect, the primary orchestrator is a network function virtualization orchestrator or a network service orchestrator, and the secondary orchestrator is a network function virtualization orchestrator or a network service orchestrator.

According to a first possible implementation of a fourth aspect of this application, this application provides a method for on-boarding a network service descriptor, including:

receiving a verification command sent by a primary orchestrator, where the verification command is used to instruct a secondary orchestrator to verify whether VNF packet information corresponding to a management domain of the secondary orchestrator is available, and the verification command includes the VNF packet information corresponding to the management domain of the secondary orchestrator;

verifying, according to the verification command, whether the VNF packet information is available; and

when it is verified that the VNF packet information is available, feeding back a notification message indicating that the VNF packet information is available to the primary orchestrator, where

a management domain of the primary orchestrator is different from the management domain of the secondary orchestrator.

With reference to a second implementation of the fourth aspect, the verification command carries a VNF packet identifier corresponding to the management domain of the secondary orchestrator, and the verifying, according to the verification command, whether the VNF packet information is available includes:

verifying, according to the VNF packet identifier corresponding to the management domain of the secondary orchestrator, whether a VNF packet and an external interface in the management domain of the secondary orchestrator are available; and

when the VNF packet and the external interface are available, feeding back a notification message indicating that the VNF packet information is available to the primary orchestrator; or

when the VNF packet and the external interface are unavailable, on-boarding the VNF packet corresponding to the management domain of the secondary orchestrator.

With reference to a third possible implementation of the fourth aspect, the on-boarding the VNF packet corresponding to the management domain of the secondary orchestrator includes:

feeding back a verification reply command to the primary orchestrator, where the verification reply command carries identifier information about one or more VNF packets that are unavailable in the management domain of the secondary orchestrator;

receiving a VNF packet on-boarding command from the primary orchestrator, where the VNF packet on-boarding command includes identifier information about a VNF packet needing to be on-boarded and metadata information about the VNF packet, the metadata information about the VNF packet including one or more of a VNF descriptor, VNF software image information, or VNF software version information; and

on-boarding, according to the VNF packet on-boarding command, the VNF packet in the management domain of the secondary orchestrator.

With reference to a fourth possible implementation of the fourth aspect, after the VNF packet in the management domain of the secondary orchestrator is on-boarded, the method further includes:

feeding back, to the primary orchestrator, a VNF packet on-board acknowledge command carrying a success indication.

With reference to a fifth possible implementation of the fourth aspect, the primary orchestrator is a network function virtualization orchestrator or a network service orchestrator, and the secondary orchestrator is a network function virtualization orchestrator or a network service orchestrator.

According to a first possible implementation of a fifth aspect of this application, this application provides an apparatus for on-boarding a network service descriptor, including:

a first receiving unit, configured to receive a cross-domain network service descriptor NSD on-boarding command from a sender;

a first determining unit, configured to determine, according to the cross-domain NSD on-boarding command, that a secondary orchestrator needs to on-board an NSD corresponding to a management domain of the secondary orchestrator; and

a first sending unit, configured to send an NSD on-boarding command to the secondary orchestrator, where the NSD on-boarding command is used to instruct the secondary orchestrator to on-board the NSD corresponding to the management domain of the secondary orchestrator, where

a management domain of the apparatus for on-boarding a network service descriptor is different from the management domain of the secondary orchestrator.

With reference to a second possible implementation of the fifth aspect, the first determining unit is further configured to:

determine, according to the cross-domain NSD on-boarding command, that the apparatus for on-boarding a network service descriptor needs to on-board an NSD corresponding to the management domain of the apparatus for on-boarding a network service descriptor.

With reference to a third possible implementation of the fifth aspect, the cross-domain NSD on-boarding command carries NSD information for describing a network service NS and VNF packet information, and the first determining unit is specifically configured to:

determine, according to the cross-domain NSD on-boarding command, the NSD information and the VNF packet information that correspond to the management domain of the apparatus for on-boarding a network service descriptor.

With reference to a fourth possible implementation of the fifth aspect, the first determining unit is specifically configured to:

determine, according to the cross-domain NSD on-boarding command, NSD information and VNF packet information that correspond to the management domain of the secondary orchestrator; and

the first sending unit is specifically configured to:

send, to the secondary orchestrator, an NSD on-boarding command carrying the NSD information and the VNF packet information that correspond to the management domain of the secondary orchestrator.

With reference to a fifth possible implementation of the fifth aspect, the first determining unit is specifically configured to:

determine, according to the cross-domain NSD on-boarding command, an NSD identifier and/or a VNF packet identifier that correspond/corresponds to the management domain of the secondary orchestrator; or

determine, according to the cross-domain NSD on-boarding command, an NSD identifier used to describe the NS, an identifier of the apparatus for on-boarding a network service descriptor, a correspondence between an identifier used to describe a VNF packet of the NS and the identifier of the apparatus for on-boarding a network service descriptor, and/or a correspondence between the identifier used to describe the VNF packet of the NS and an identifier of the secondary orchestrator.

With reference to a sixth possible implementation of the fifth aspect, the first receiving unit is further configured to:

after the NSD on-boarding command is sent to the secondary orchestrator, receive an NSD on-boarding complete notification message fed back by the secondary orchestrator; and

the first sending unit is further configured to: after an NSD corresponding to the management domain of the apparatus for on-boarding a network service descriptor is on-boarded, send a cross-domain NSD on-boarding complete notification message to the sender.

With reference to a seventh possible implementation of the fifth aspect, the apparatus for on-boarding a network service descriptor is a network function virtualization orchestrator or a network service orchestrator; and

the secondary orchestrator is a network function virtualization orchestrator or a network service orchestrator.

According to a first possible implementation of a sixth aspect of this application, this application provides an apparatus for on-boarding a network service descriptor, including:

a second receiving unit, configured to receive an NSD on-boarding command sent by a primary orchestrator, where the NSD on-boarding command is used to instruct the apparatus for on-boarding a network service descriptor to on-board an NSD corresponding to a management domain of the apparatus for on-boarding a network service descriptor; and

a second executing unit, configured to on-board, according to the NSD on-boarding command, the NSD corresponding to the management domain of the apparatus for on-boarding a network service descriptor, where

the management domain of the apparatus for on-boarding a network service descriptor is different from a management domain of the primary orchestrator.

With reference to a second possible implementation of the sixth aspect, the apparatus further includes:

a second sending unit, configured to: after the NSD corresponding to the management domain of the apparatus for on-boarding a network service descriptor is on-boarded, send an NSD on-boarding complete notification message to the primary orchestrator.

With reference to a third possible implementation of the sixth aspect, the primary orchestrator is a network function virtualization orchestrator or a network service orchestrator, and the apparatus for on-boarding a network service descriptor is a network function virtualization orchestrator or a network service orchestrator.

According to a first possible implementation of a seventh aspect of this application, this application provides an apparatus for on-boarding a network service descriptor, including:

a third receiving unit, configured to receive a cross-domain network service descriptor NSD on-boarding command from a sender;

a second determining unit, configured to: in a process of on-boarding an NSD by the apparatus for on-boarding a network service descriptor, determine, according to the cross-domain NSD on-boarding command, that a secondary orchestrator needs to verify VNF packet information corresponding to a management domain of the secondary orchestrator; and

a third sending unit, configured to send a verification command to the secondary orchestrator, where the verification command is used to instruct the secondary orchestrator to verify whether the VNF packet information is available, and the verification command includes the VNF packet information, where

the third receiving unit is further configured to receive a notification message indicating that the VNF packet information is available, where the notification message is fed back when the secondary orchestrator verifies that the VNF packet information is available, where

the apparatus for on-boarding a network service descriptor and the secondary orchestrator have different management domains respectively.

With reference to a second possible implementation of the seventh aspect, the cross-domain NSD on-boarding command carries NSD information for describing a network service NS and the VNF packet information, and the second determining unit is specifically configured to:

determine, according to the cross-domain NSD on-boarding command, the NSD information and the VNF packet information corresponding to the management domain of the apparatus for on-boarding a network service descriptor that are used to describe the NS.

With reference to a third possible implementation of the seventh aspect, the second determining unit is specifically configured to:

determine, according to the cross-domain NSD on-boarding command, a VNF packet identifier corresponding to the management domain of the secondary orchestrator;

the third sending unit is specifically configured to:

send, to the secondary orchestrator, the verification command carrying the VNF packet identifier corresponding to the management domain of the secondary orchestrator, where the verification command carrying the VNF packet identifier corresponding to the management domain of the secondary orchestrator is used to instruct the secondary orchestrator to verify, according to the VNF packet identifier corresponding to the management domain of the secondary orchestrator, whether a VNF packet and an external interface in the management domain of the secondary orchestrator are available; and

the third receiving unit is specifically configured to receive a notification message indicating that the VNF packet information is available, where the notification message is fed back when the secondary orchestrator verifies that the VNF packet and the external interface in the management domain of the secondary orchestrator are available; or receive a verification reply command indicating that the VNF packet information is unavailable, where the verification reply command is fed back when the secondary orchestrator verifies that the VNF packet and the external interface in the management domain of the secondary orchestrator are unavailable.

With reference to a fourth possible implementation of the seventh aspect, the third receiving unit is specifically configured to:

receive a VNF packet on-board acknowledge command that carries a success indication and that is fed back by the secondary orchestrator; and

the third sending unit is specifically configured to: after the NSD corresponding to the management domain of the apparatus for on-boarding a network service descriptor is on-boarded, send a cross-domain NSD on-boarding complete notification message to the sender.

With reference to a fifth possible implementation of the seventh aspect, the apparatus for on-boarding a network service descriptor is a network function virtualization orchestrator or a network service orchestrator; and

the secondary orchestrator is a network function virtualization orchestrator or a network service orchestrator.

According to a first possible implementation of an eighth aspect of this application, this application provides an apparatus for on-boarding a network service descriptor, including:

a fourth receiving unit, configured to receive a verification command sent by a primary orchestrator, where the verification command is used to instruct the apparatus for on-boarding a network service descriptor to verify whether VNF packet information corresponding to a management domain of the apparatus for on-boarding a network service descriptor is available, and the verification command includes the VNF packet information corresponding to the management domain of the apparatus for on-boarding a network service descriptor; and

a verification unit, configured to verify, according to the verification command, whether the VNF packet information is available, where

the management domain of the apparatus for on-boarding a network service descriptor is different from a management domain of the primary orchestrator.

With reference to a second possible implementation of the eighth aspect, the verification command carries a VNF packet identifier corresponding to the management domain of the apparatus for on-boarding a network service descriptor, and the verification unit is specifically configured to:

verify, according to the VNF packet identifier corresponding to the management domain of the apparatus for on-boarding a network service descriptor, whether a VNF packet and an external interface in the management domain of the apparatus for on-boarding a network service descriptor are available; and

when the VNF packet and the external interface in the management domain of the apparatus for on-boarding a network service descriptor are available, trigger a fourth sending unit to feed back a notification message indicating that the VNF packet information is available to the primary orchestrator; or

when the VNF packet and the external interface in the management domain of the apparatus for on-boarding a network service descriptor are unavailable, trigger a fourth executing unit to on-board a VNF packet corresponding to the management domain of the secondary orchestrator.

With reference to a third possible implementation of the eighth aspect, the fourth executing unit is specifically configured to:

feed back a verification reply command to the primary orchestrator, where the verification reply command carries identifier information about one or more VNF packets that are unavailable in the management domain of the apparatus for on-boarding a network service descriptor;

receive a VNF packet on-boarding command from the primary orchestrator, where the VNF packet on-boarding command includes identifier information about a VNF packet needing to be on-boarded and metadata information about the VNF packet, the metadata information about the VNF packet including one or more of a VNF descriptor, VNF software image information, or VNF software version information; and

on-board, according to the VNF packet on-boarding command, the VNF packet in the management domain of the apparatus for on-boarding a network service descriptor.

With reference to a fourth possible implementation of the eighth aspect, the fourth sending unit is further configured to feed back, to the primary orchestrator, a VNF packet on-board acknowledge command carrying a success indication.

With reference to a fifth possible implementation of the eighth aspect, the primary orchestrator is a network function virtualization orchestrator or a network service orchestrator, and the apparatus for on-boarding a network service descriptor is a network function virtualization orchestrator or a network service orchestrator.

It can be learned from the foregoing technical solutions that, according to the method and the apparatus for on-boarding a network service descriptor of this application, the primary orchestrator receives the cross-domain network service descriptor NSD on-boarding command from the sender; the primary orchestrator determines, according to the cross-domain NSD on-boarding command, that the secondary orchestrator needs to on-board the NSD corresponding to the management domain of the secondary orchestrator; and the primary orchestrator sends the NSD on-boarding command to the secondary orchestrator, where the NSD on-boarding command is used to instruct the secondary orchestrator to on-board the NSD corresponding to the management domain of the secondary orchestrator, and the management domain of the primary orchestrator is different from the management domain of the secondary orchestrator. The method and the apparatus can be applied to NS deployment across NFVO management domains, so as to ensure consistency and reliability of an NSD on-boarding process in a scenario of NS deployment across NFVO management domains.

### BRIEF DESCRIPTION OF DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram of a detailed architecture of MANO;

FIG. 2 is a schematic architecture diagram of an NS deployed in different NFVO management domains;

FIG. 3 is a flowchart of Embodiment 1 of a method for on-boarding a network service descriptor NSD disclosed in the present disclosure;

FIG. 4 is a flowchart of Embodiment 2 of a method for on-boarding a network service descriptor NSD disclosed in the present disclosure;

FIG. 5 is a signaling diagram of a method for on-boarding a network service descriptor NSD disclosed in the present disclosure;

FIG. 6 is a flowchart of Embodiment 3 of a method for on-boarding a network service descriptor NSD disclosed in the present disclosure;

FIG. 7 is a flowchart of Embodiment 4 of a method for on-boarding a network service descriptor NSD disclosed in the present disclosure;

FIG. 8 is a signaling diagram of a method for on-boarding a network service descriptor NSD disclosed in the present disclosure;

FIG. 9 is a structural diagram of Embodiment 1 of an apparatus for on-boarding a network service descriptor NSD disclosed in the present disclosure;

FIG. 10 is a structural diagram of Embodiment 2 of an apparatus for on-boarding a network service descriptor NSD disclosed in the present disclosure;

FIG. 11 is a structural diagram of Embodiment 3 of an apparatus for on-boarding a network service descriptor NSD disclosed in the present disclosure;

FIG. 12 is a structural diagram of Embodiment 4 of an apparatus for on-boarding a network service descriptor NSD disclosed in the present disclosure; and

FIG. 13 is a structural diagram of an apparatus for on-boarding a network service descriptor NSD disclosed in this application.

### DESCRIPTION OF EMBODIMENTS

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

In the specification, claims, and the foregoing drawings, the terms “include”, “contain” and any other variants mean to cover the non-exclusive inclusion, so that a process, method, system, product, or device that includes a series of units is not necessarily limited to those units, but may include other units not expressly listed or inherent to such a process, method, system, product, or device.

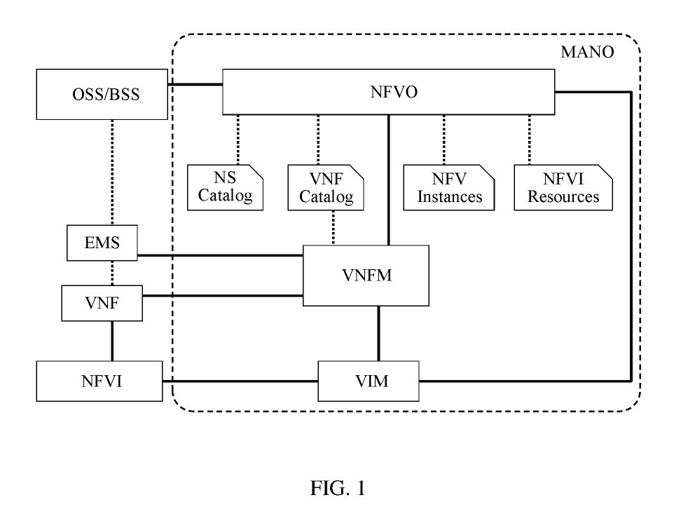

Currently, standardized work of NFV is focused on MANO functions. As shown in FIG. 1, FIG. 1 shows a detailed architecture of MANO, including a VIM, an NFVO, and a VNFM. The NFVO is responsible for life cycle management on an NS, and orchestrates and manages virtualized resources (including a hardware resource and a software resource) of the entire NFV system. In addition, the MANO further includes: an NS catalog, a VNF catalog, NFV instances, and NFVI resources. Optionally, the NS catalog and the VNF catalog are included in the NFVO. In the figure:

The NS catalog stores all on-boarded NSD information.

The VNF catalog stores all on-board VNF packages. Optionally, the VNF package includes a VNF descriptor (VNFD) and a virtual machine image. An on-boarding process of the VNF package means registering the VNF package in the VNF catalog, to ensure that a metadata VNFD and a VNF image that forms the VNF packet are available in the catalog.

The NFV Instances store status information about instances such as all NSs and VNFs that are running, for example, an allocated network address and an operation record.

The NFVI Resources store status of all NFVI resources, including available, reserved, or allocated NFVI resources.

In actual NFV MANO application, a mapping exists between a management domain of the NFVO and a management domain of an operator network. For example, for an operator in a small or medium-sized country, one NFVO management domain may be mapped to nationwide networks of the operator; however, for an operator in a superpower such as China or America, one NFVO management domain may be mapped to only networks of the operator in a province.

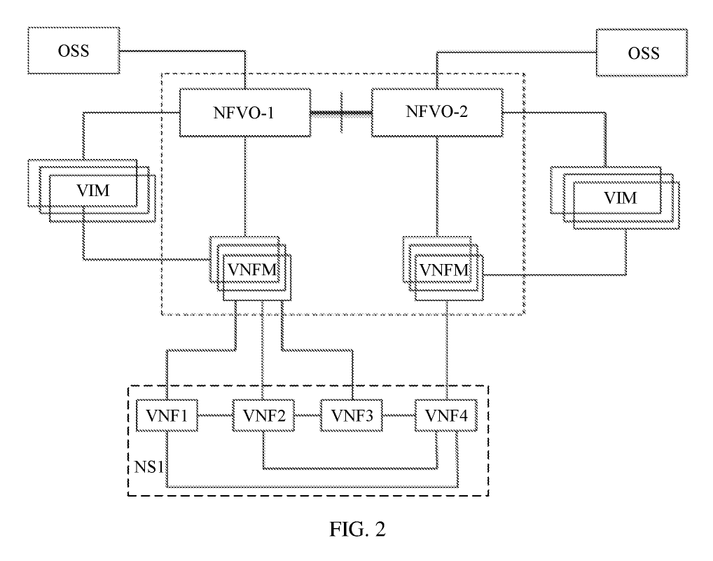

In some application scenarios, for example, when an NFV technology is used in an enterprise network of a global enterprise, or when a VNF in an inactive zone is selected to perform redundancy and backup for a VNF in an active zone of tsunamis and earthquakes (the active zone and the inactive zone usually cross different countries or different provinces), an NS needs to be deployed in different NFVO management domains. As shown in FIG. 2, two NFVOs (NFVO 1 and NFVO 2) of different management domains complete NS deployment across NFVO management domains by using a horizontal interface (a bold line between the NFVO 1 and NFVO 2 in FIG. 2). In the figure, a VNF 1, a VNF 2, a VNF 3, and a VNF 4 jointly form an NS 1, where the VNF 1 to VNF 3 are deployed in the management domain of the NFVO 1, and the VNF 4 is deployed in the management domain of the NFVO2.

The following describes the technical solution of this application by way of an embodiment.

For ease of description, in this embodiment of the present disclosure, a primary orchestrator and a secondary orchestrator are used as an example. However, based on the solution of this application, an application scenario in which there is a primary orchestrator and multiple secondary orchestrators also falls within the protection scope of this application. It should be noted that, the primary orchestrator and the secondary orchestrator separately manage different management domains. In addition, the primary orchestrator and the secondary orchestrator may be NFVOs, or network service orchestrators (NSOs). An NSO is a sub-orchestrator that is obtained after an NFVO entity is split, and is responsible for management and orchestration of network services. Another sub-orchestrator that is obtained after the NFVO entity is split is a resource orchestrator (RO), which is mainly responsible for management and orchestration of virtual resources.

For example, both the primary orchestrator and the secondary orchestrator are NFVOs. As shown in FIG. 2, the NFVO 1 maybe specified as the primary orchestrator, and the NFVO 2 may be specified as the secondary orchestrator. In the figure, the NS 1 includes four VNFs, that is, the VNF 1, the VNF 2, the VNF 3, and the VNF 4. Each VNF corresponds to a physical network function (PNF) in a conventional non-virtualized network, for example, a virtualized evolved packet core (EPC) node. Optionally, the EPC node is a mobility management entity (MME) , a serving gateway (SGW) , or a public data network gateway (PGW). The VNF 1 to the VNF 3 are deployed in the management domain of the NFVO 1, and the VNF 4 is deployed in the management domain of the NFVO 2.

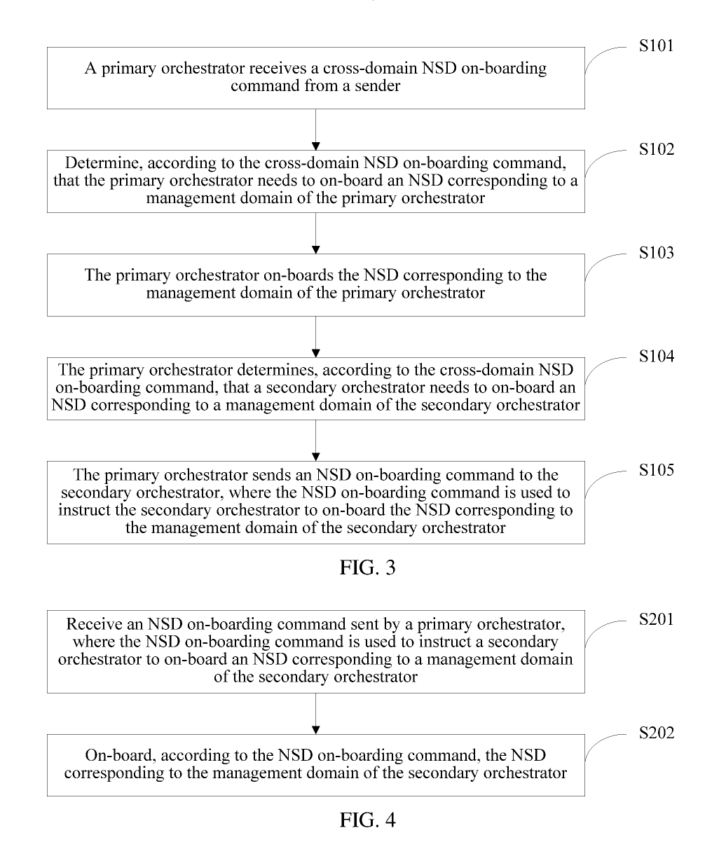

Referring to FIG. 3, FIG. 3 is a flowchart of Embodiment 1 of a method for on-boarding a network service descriptor NSD disclosed in the present disclosure. The method is applied to a primary orchestrator, and specifically includes the following steps:

S101. The primary orchestrator receives a cross-domain NSD on-boarding command from a sender.

The sender includes, but is not limited to, an operation support system (OSS)/a business support system (BSS) of an operator.

The cross-domain NSD on-boarding command carries NSD information for describing a network service NS and VNF information. Specifically, the NSD information is an NSD identifier, and the VNF information is a VNF package identifier.

S102. Determine, according to the cross-domain NSD on-boarding command, that the primary orchestrator needs to on-board an NSD corresponding to a management domain of the primary orchestrator.

Specifically, the NSD information (for example, the NSD identifier) and the VNF packet information (for example, the VNF packet identifier) that correspond to the management domain of the primary orchestrator may be determined from the cross-domain NSD on-boarding command, thereby determining, according to the NSD information and the VNF packet information, that the primary orchestrator needs to on-board the NSD corresponding to the management domain of the primary orchestrator.

S103. The primary orchestrator on-boards the NSD corresponding to the management domain of the primary orchestrator.

It should be noted that, the on-boarding, by the primary orchestrator, the NSD corresponding to the management domain of the primary orchestrator specifically includes:

checking, according to the NSD information corresponding to the management domain of the primary orchestrator, whether a corresponding element exists;

checking, according to the VNF packet information corresponding to the management domain of the primary orchestrator, whether a corresponding VNF packet exists;

checking, according to the VNF packet information corresponding to the management domain of the primary orchestrator, whether a corresponding VNFD includes a corresponding VNF external interface; and

when results of the three checks are all yes, notifying, by the primary orchestrator, an NSD catalog to on-board the NSD into the catalog, where in this case, the primary orchestrator completes on-boarding the NSD corresponding to the management domain of the primary orchestrator.

When it is checked, according to the VNF packet information corresponding to the management domain of the primary orchestrator, that the VNF does not exist and/or it is checked, according to the VNF packet information corresponding to the management domain of the primary orchestrator, that the VNFD does not include the corresponding VNF external interface, the on-boarding, by the primary orchestrator, the NSD corresponding to the management domain of the primary orchestrator further includes: sending, by the primary orchestrator to the sender, an on-board acknowledge command with a failure cause indication, where the on-board acknowledge command is used to notify the sender that the VNF packet in the VNF in the management domain of the primary orchestrator does not exist; receiving, by the primary orchestrator, a VNF packet on-boarding command from the sender; and on-boarding, by the primary orchestrator according to the VNF packet on-boarding command, the VNF packet in the domain of the primary orchestrator. When on-boarding of the VNF packet is completed, it indicates that the primary orchestrator completes on-boarding the NSD corresponding to the management domain of the primary orchestrator.

It should be noted that, in this embodiment, the VNF packet on-boarding command carries a VNFD and software image information of the VNF packet, the completing on-boarding the VNF packet according to the VNF packet on-boarding command specifically includes:

checking whether a mandatory element in the VNFD exists;

if the mandatory element in the VNFD exists, notifying a VNF packet to on-board the VNF packet into the catalog;

uploading the software image of the VNF packet to a VIM;

receiving a notification that is returned by the VIM and that indicates that uploading of the software image of the VNF packet is completed; and

returning notification information that a process of on-boarding the VNF packet is completed to the sender.

S104. The primary orchestrator determines, according to the cross-domain NSD on-boarding command, that a secondary orchestrator needs to on-board an NSD corresponding to a management domain of the secondary orchestrator.

Specifically, NSD information and VNF packet information that correspond to the management domain of the secondary orchestrator may be determined from the cross-domain NSD on-boarding command, thereby determining, according to the NSD information and the VNF packet information, that the secondary orchestrator needs to on-board the NSD corresponding to the management domain of the secondary orchestrator.

In an actual application, the primary orchestrator may decompose the NS into a sub-NS corresponding to the management domain of the secondary orchestrator. An NSD identifier and/or a VNF packet identifier that correspond/corresponds to the management domain of the secondary orchestrator is used to describe the sub-NS. The determining NSD information and VNF packet information that correspond to the management domain of the secondary orchestrator from the cross-domain NSD on-boarding command specifically includes: determining, according to the cross-domain NSD on-boarding command, the NSD identifier and/or the VNF packet identifier that correspond/corresponds to the management domain of the secondary orchestrator.

In addition, an NSD identifier used to describe the NS, an identifier of the primary orchestrator, a correspondence between an identifier used to describe a VNF packet of the NS and the identifier of the primary orchestrator, and/or a correspondence between the identifier used to describe the VNF packet of the NS and an identifier of the secondary orchestrator may also be determined from the cross-domain NSD on-boarding command, to serve as the NSD information and the VNF packet information that correspond to the management domain of the secondary orchestrator.

S105. The primary orchestrator sends an NSD on-boarding command to the secondary orchestrator, where the NSD on-boarding command is used to instruct the secondary orchestrator to on-board the NSD corresponding to the management domain of the secondary orchestrator.

The sending an NSD on-boarding command to the secondary orchestrator may specifically include: sending, to the secondary orchestrator, the NSD on-boarding command carrying the NSD information and the VNF packet information that correspond to the management domain of the secondary orchestrator.

It should further be noted that, after step S105, the method further includes:

receiving an NSD on-boarding complete notification message fed back by the secondary orchestrator; and

after an NSD corresponding to the management domain of the primary orchestrator is on-boarded, sending a cross-domain NSD on-boarding complete notification message to the sender.

Referring to FIG. 4, FIG. 4 is a flowchart of Embodiment 2 of a method for on-boarding a network service descriptor NSD disclosed in the present disclosure. The method is applied to a secondary orchestrator, and specifically includes the following steps:

S201. Receive an NSD on-boarding command sent by a primary orchestrator.

The NSD on-boarding command is used to instruct the secondary orchestrator to on-board an NSD corresponding to a management domain of the secondary orchestrator.

The NSD on-boarding command carries NSD information and VNF packet information that correspond to the management domain of the secondary orchestrator. Specifically, the NSD on-boarding command carries an NSD identifier and/or a VNF packet identifier that correspond/corresponds to the management domain of the secondary orchestrator. Alternatively, the NSD on-boarding command carries an NSD identifier used to describe an NS, an identifier of the primary orchestrator, a correspondence between an identifier of a VNF packet used to describe the NS and the identifier of the primary orchestrator, and/or a correspondence between the identifier of the VNF packet used to describe the NS and an identifier of the secondary orchestrator.

S202. On-board, according to the NSD on-boarding command, the NSD corresponding to the management domain of the secondary orchestrator.

It should be noted that, the on-boarding, according to the NSD on-boarding command, the NSD corresponding to the management domain of the secondary orchestrator specifically includes:

checking, according to the NSD information corresponding to the management domain of the secondary orchestrator, whether a corresponding element exists;

checking, according to the VNF packet information corresponding to the management domain of the secondary orchestrator, whether a corresponding VNF packet exists; and

checking, according to the VNF packet information corresponding to the management domain of the secondary orchestrator, whether a corresponding VNFD includes a corresponding VNF external interface.

When results of the three checks are all yes, it indicates that on-boarding of the NSD corresponding to the management domain of the secondary orchestrator is completed.

When it is checked, according to the VNF packet information corresponding to the management domain of the secondary orchestrator, that the VNF does not exist and/or it is checked, according to the VNF packet information corresponding to the management domain of the secondary orchestrator, that the VNFD does not include the corresponding VNF external interface, the on-boarding the NSD corresponding to the management domain of the secondary orchestrator further includes: sending, to the sender, an on-board acknowledge command with a failure cause indication, where the on-board acknowledge command is used to indicate that the VNF packet in the VNF in the management domain of the secondary orchestrator does not exist and/or the corresponding VNFD does not include the corresponding VNF external interface; receiving a VNF packet on-boarding command from the sender; and on-boarding, according to the VNF packet on-boarding command, the VNF packet in the management domain of the secondary orchestrator. When on-boarding of the VNF packet is completed, it indicates that on-boarding of the NSD corresponding to the management domain of the secondary orchestrator is completed.

Refer to the foregoing embodiment for related descriptions of the process of on-boarding the VNF packet, and details are not described again in this embodiment.

It should further be noted that, after the NSD corresponding to the management domain of the secondary orchestrator is on-boarded, an NSD on-boarding complete notification message is fed back to the primary orchestrator.

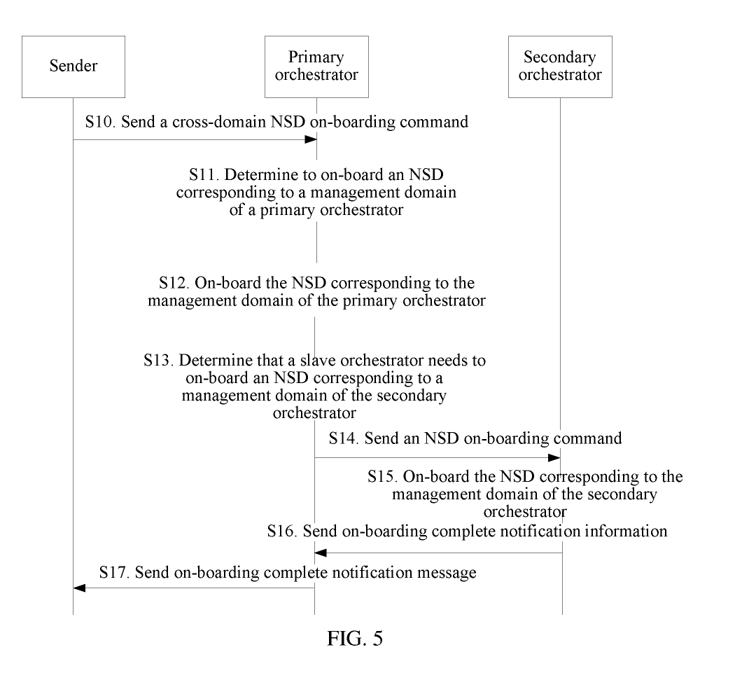

Referring to FIG. 5, FIG. 5 is a signaling diagram of a method for on-boarding a network service descriptor NSD disclosed in the present disclosure. The method includes:

S10. A sender sends a cross-domain NSD on-boarding command to a primary orchestrator.

S11. The primary orchestrator determines, according to the received cross-domain NSD on-boarding command, to on-board an NSD corresponding to a management domain of the primary orchestrator.

S12. The primary orchestrator on-boards the NSD corresponding to the management domain of the primary orchestrator.

S13. The primary orchestrator determines, according to the received cross-domain NSD on-boarding command, that a secondary orchestrator needs to on-board an NSD corresponding to a management domain of the secondary orchestrator.

S14. The primary orchestrator sends an NSD on-boarding command to the secondary orchestrator.

S15. The secondary orchestrator on-boards, according to the received NSD on-boarding command, the NSD corresponding to the management domain of the secondary orchestrator.

S16. After completing on-boarding the NSD corresponding to the management domain of the secondary orchestrator, the secondary orchestrator sends an on-boarding complete notification message to the primary orchestrator.

S17. After completing on-boarding the NSD corresponding to the management domain of the primary orchestrator, the primary orchestrator sends an on-boarding complete notification message to the sender.

It should be noted that, for specific implementation of each of the foregoing steps, refer to the descriptions of Embodiment 1 and Embodiment 2 of a method for on-boarding a network service descriptor NSD, and details are not described herein again.

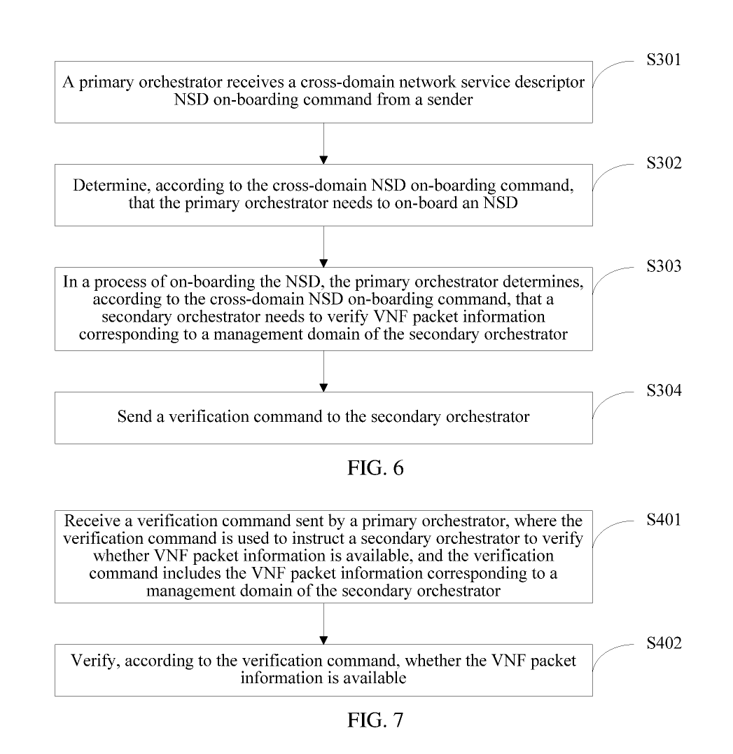

Referring to FIG. 6, FIG. 6 is a flowchart of Embodiment 3 of a method for on-boarding a network service descriptor NSD disclosed in the present disclosure. The method is applied to a primary orchestrator, and specifically includes the following steps:

S301. The primary orchestrator receives a cross-domain network service descriptor NSD on-boarding command from a sender.

The sender includes, but is not limited to, an OSS/a BSS of an operator.

The cross-domain NSD on-boarding command carries NSD information for describing an NS and VNF information.

S302. Determine, according to the cross-domain NSD on-boarding command, that the primary orchestrator needs to on-board an NSD.

Specifically, the NSD information and the VNF packet information corresponding to a management domain of the primary orchestrator that are used to describe the NS may be determined from the cross-domain NSD on-boarding command. Specifically, the NSD information is an NSD identifier, and the VNF information is a VNF package identifier.

S303. In a process of on-boarding the NSD, the primary orchestrator determines, according to the cross-domain NSD on-boarding command, that a secondary orchestrator needs to verify VNF packet information corresponding to a management domain of the secondary orchestrator.

The on-boarding the NSD by the primary orchestrator specifically includes: checking, according to the NSD information, whether a corresponding element exists; checking, according to the VNF packet information corresponding to the management domain of the primary orchestrator, whether a corresponding VNF packet exists; checking, according to the VNF packet information corresponding to the management domain of the primary orchestrator, whether a VNFD includes a corresponding VNF external interface; and when results of the three checks are all yes, notifying, by the primary orchestrator, an NSD catalog to on-board the NSD into the catalog. In this case, the primary orchestrator completes on-boarding the NSD corresponding to the management domain of the primary orchestrator. When it is checked, according to the VNF packet information corresponding to the management domain of the primary orchestrator, that the VNF does not exist and/or it is checked, according to the VNF packet information corresponding to the management domain of the primary orchestrator, that the VNFD does not include the corresponding VNF external interface, the on-boarding, by the primary orchestrator, the NSD corresponding to the management domain of the primary orchestrator includes: sending, by the primary orchestrator to the sender, an on-board acknowledge command with a failure cause indication, where the on-board acknowledge command is used to notify the sender that the VNF packet in the VNF in the management domain of the primary orchestrator does not exist; receiving, by the primary orchestrator, a VNF packet on-boarding command from the sender; and on-boarding, by the primary orchestrator according to the VNF packet on-boarding command, the VNF packet in the VNF in the management domain of the primary orchestrator. In this case, the primary orchestrator completes on-boarding the NSD corresponding to the management domain of the primary orchestrator.

The determining, according to the cross-domain NSD on-boarding command, that a secondary orchestrator needs to verify VNF packet information corresponding to the management domain of the secondary orchestrator specifically includes: determining, according to the cross-domain NSD on-boarding command, a VNF packet identifier corresponding to the management domain of the secondary orchestrator.

S304. Send a verification command to the secondary orchestrator.

The verification command includes the VNF packet information corresponding to the management domain of the secondary orchestrator. The verification command is used to instruct the secondary orchestrator to verify whether the VNF packet information corresponding to the management domain of the secondary orchestrator is available. When the secondary orchestrator verifies that the VNF packet information is available, the secondary orchestrator feeds back a notification message indicating that the VNF packet information is available to the primary orchestrator, and the primary orchestrator receives the notification message indicating that the VNF packet information is available.

In S304, the sending a verification command to the secondary orchestrator specifically includes:

sending, to the secondary orchestrator, the verification command carrying the VNF packet identifier corresponding to the management domain of the secondary orchestrator, where the verification command carrying the VNF packet identifier corresponding to the management domain of the secondary orchestrator is used to instruct the secondary orchestrator to verify, according to the VNF packet identifier corresponding to the management domain of the secondary orchestrator, whether a VNF packet and an external interface that are in the management domain of the secondary orchestrator are available; and when the VNF packet and the external interface are available, feeding back, by the secondary orchestrator, the notification message indicating that the VNF packet information is available to the primary orchestrator, and receiving, by the primary orchestrator, the notification message indicating that the VNF packet information is available; or when the VNF packet and the external interface are unavailable, on-boarding, by the secondary orchestrator, a VNF packet corresponding to the management domain of the secondary orchestrator. Specifically, the secondary orchestrator feeds back a verification reply command indicating that the VNF packet information is unavailable to the primary orchestrator, and the primary orchestrator receives the verification reply command indicating that the VNF packet information is unavailable.

It should further be noted that, after S304, the method further includes:

receiving a VNF packet on-board acknowledge command that carries a success indication and that is fed back by the secondary orchestrator; and

after the NSD corresponding to the management domain of the primary orchestrator is on-boarded, sending a cross-domain NSD on-boarding complete notification message to the sender.

Referring to FIG. 7, FIG. 7 is a flowchart of Embodiment 4 of a method for on-boarding a network service descriptor NSD disclosed in the present disclosure. The method is applied to a secondary orchestrator, and specifically includes the following steps:

S401. Receive a verification command sent by a primary orchestrator.

The verification command is used to instruct the secondary orchestrator to verify whether VNF packet information corresponding to a management domain of the secondary orchestrator is available. The verification command includes the VNF packet information corresponding to the management domain of the secondary orchestrator.

S402. Verify, according to the verification command, whether the VNF packet information is available.

The verification command carries a VNF packet identifier corresponding to the management domain of the secondary orchestrator, and the verifying whether the VNF packet information is available includes:

verifying, according to the VNF packet identifier corresponding to the management domain of the secondary orchestrator, whether a VNF packet and an external interface in the management domain of the secondary orchestrator are available; and

when the VNF packet and the external interface are available, feeding back a notification message indicating that the VNF packet information is available to the primary orchestrator; or

when the VNF packet and the external interface are unavailable, on-boarding the VNF packet corresponding to the management domain of the secondary orchestrator.

Specifically, the verifying, according to the VNF packet identifier corresponding to the management domain of the secondary orchestrator, whether a VNF packet and an external interface in the management domain of the secondary orchestrator are available includes: checking, according to the VNF packet identifier corresponding to the management domain of the secondary orchestrator, whether a corresponding VNF exists; and checking, according to the VNF packet identifier corresponding to the management domain of the secondary orchestrator, whether a corresponding VNFD includes a corresponding VNF external interface.

When it is checked, according to the VNF packet identifier corresponding to the management domain of the secondary orchestrator, that the corresponding VNF packet does not exist, and/or it is checked, according to the VNF packet identifier corresponding to the management domain of the secondary orchestrator, that the corresponding VNFD does not include the corresponding VNF external interface, it indicates that the secondary orchestrator verifies that the VNF packet information is unavailable, and the secondary orchestrator needs to on-board the VNF packet corresponding to the management domain of the secondary orchestrator.

A process of on-boarding the VNF packet corresponding to the management domain of the secondary orchestrator by the secondary orchestrator specifically includes: feeding back a verification reply command to the primary orchestrator, where the verification reply command carries identifier information about one or more VNF packets that are unavailable in the management domain of the secondary orchestrator;

receiving a VNF packet on-boarding command from the primary orchestrator, where the VNF packet on-boarding command includes identifier information about a VNF packet needing to be on-boarded and metadata information about the VNF packet, where the metadata information about the VNF packet includes one or more of a VNF descriptor, VNF software image information, or VNF software version information; and

on-boarding, according to the VNF packet on-boarding command, the VNF packet in the management domain of the secondary orchestrator.

After the VNF packet in the management domain of the secondary orchestrator is on-boarded, the method further includes:

feeding back, to the primary orchestrator, a VNF packet on-board acknowledge command carrying a success indication.

When it is checked, according to the VNF packet identifier corresponding to the management domain of the secondary orchestrator, that the corresponding VNF packet exists, and/or it is checked, according to the VNF packet identifier corresponding to the management domain of the secondary orchestrator, that the corresponding VNFD includes the corresponding VNF external interface, it indicates that the secondary orchestrator verifies that the VNF packet information is available, and the secondary orchestrator feeds back a notification message indicating that the VNF packet information is available to the primary orchestrator.

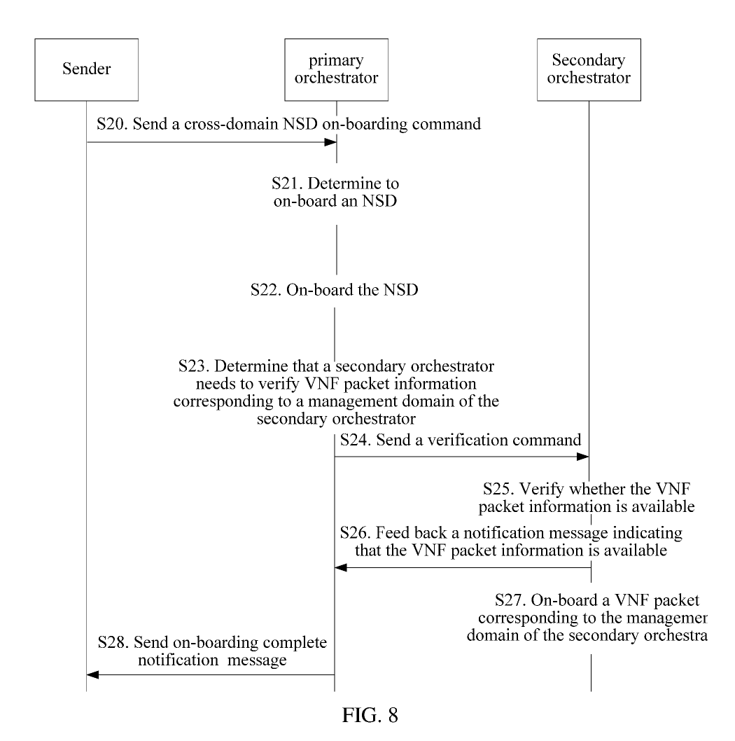

Referring to FIG. 8, FIG. 8 is a signaling diagram of a method for on-boarding a network service descriptor NSD disclosed in the present disclosure. The method includes:

S20. A sender sends a cross-domain NSD on-boarding command to a primary orchestrator.

S21. The primary orchestrator determines, according to the received cross-domain NSD on-boarding command, to on-board an NSD.

S22. The primary orchestrator on-boards the NSD.

S23. The primary orchestrator determines, according to the received cross-domain NSD on-boarding command, that a secondary orchestrator needs to verify VNF packet information corresponding to a management domain of the secondary orchestrator.

S24. The primary orchestrator sends a verification command to the secondary orchestrator.

S25. The secondary orchestrator verifies, according to the received verification command, whether the VNF packet information is available; and performs S26 when the VNF packet information is available; or performs S27 when the VNF packet information is unavailable.

S26. Feedback a notification message indicating that the VNF packet information is available to the primary orchestrator.

S27. On-board a VNF packet corresponding to the management domain of the secondary orchestrator.

S28. After the NSD corresponding to a management domain of the primary orchestrator is on-boarded, send a cross-domain NSD on-boarding complete notification message to the sender.

It should be noted that, refer to text descriptions corresponding to FIG. 6 and FIG. 7 for specific implementation of each of the foregoing steps, and details are not described herein again.

The method is described in detail in the foregoing embodiments disclosed in the present disclosure. The method may be implemented by using apparatuses in many forms. Therefore, the present disclosure further discloses an apparatus. The following provides specific embodiments to describe the apparatus in detail.

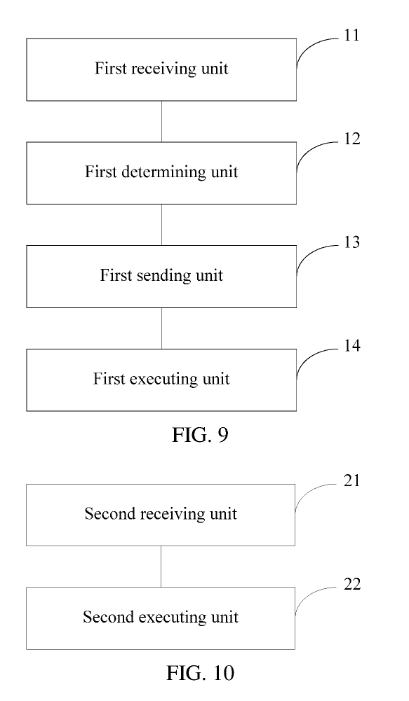

Referring to FIG. 9, FIG. 9 is a structural diagram of Embodiment 1 of an apparatus for on-boarding a network service descriptor NSD disclosed in the present disclosure. The apparatus may be a primary orchestrator, may be specifically an NFVO or an NSO, and specifically includes the following units:

a first receiving unit 11, configured to receive a cross-domain network service descriptor NSD on-boarding command from a sender;

a first determining unit 12, configured to: determine, according to the cross-domain NSD on-boarding command, that the primary orchestrator needs to on-board an NSD corresponding to a management domain of the primary orchestrator, and determine, according to the cross-domain NSD on-boarding command, that the secondary orchestrator needs to on-board an NSD corresponding to a management domain of the secondary orchestrator;

a first sending unit 13, configured to send an NSD on-boarding command to the secondary orchestrator, where the NSD on-boarding command is used to instruct the secondary orchestrator to on-board the NSD corresponding to the management domain of the secondary orchestrator; and

a first executing unit 14, configured to on-board the NSD corresponding to the management domain of the primary orchestrator by the primary orchestrator.

It should be noted that, the cross-domain NSD on-boarding command carries NSD information for describing a network service NS and VNF packet information, and the first determining unit 12 is specifically configured to:

determine, according to the cross-domain NSD on-boarding command, the NSD information and the VNF packet information that correspond to the management domain of the primary orchestrator.

The first determining unit 12 is specifically configured to:

determine, according to the cross-domain NSD on-boarding command, NSD information and VNF packet information that correspond to the management domain of the secondary orchestrator; and

the first sending unit is specifically configured to:

send, to the secondary orchestrator, an NSD on-boarding command carrying the NSD information and the VNF packet information that correspond to the management domain of the secondary orchestrator.

The first determining unit 12 is specifically configured to:

determine, according to the cross-domain NSD on-boarding command, an NSD identifier and/or a VNF packet identifier that correspond/corresponds to the management domain of the secondary orchestrator; or

determine, according to the cross-domain NSD on-boarding command, an NSD identifier used to describe the NS, an identifier of the primary orchestrator, a correspondence between an identifier used to describe a VNF packet of the NS and the identifier of the primary orchestrator, and/or a correspondence between the identifier used to describe the VNF packet of the NS and an identifier of the secondary orchestrator.

The first receiving unit 11 is further configured to:

after the NSD on-boarding command is sent to the secondary orchestrator, receive an NSD on-boarding complete notification message fed back by the secondary orchestrator; and

the first sending unit is further configured to: after the NSD corresponding to the management domain of the primary orchestrator is on-boarded, send a cross-domain NSD on-boarding complete notification message to the sender.

Referring to FIG. 10, FIG. 10 is a structural diagram of Embodiment 2 of an apparatus for on-boarding a network service descriptor NSD disclosed in the present disclosure. The apparatus may be a secondary orchestrator, may be specifically an NFVO or an NSO, and specifically includes the following units:

a second receiving unit 21, configured to receive an NSD on-boarding command sent by a primary orchestrator, where the NSD on-boarding command is used to instruct the secondary orchestrator to on-board an NSD corresponding to a management domain of the secondary orchestrator; and

a second executing unit 22, configured to on-board, according to the NSD on-boarding command, the NSD corresponding to the management domain of the secondary orchestrator.

It should be noted that, the NSD on-boarding command carries NSD information and VNF packet information that correspond to the management domain of the secondary orchestrator.

The apparatus further includes:

a second sending unit, configured to: after the NSD corresponding to the management domain of the secondary orchestrator is on-boarded, feed back an NSD on-boarding complete notification message to the primary orchestrator.

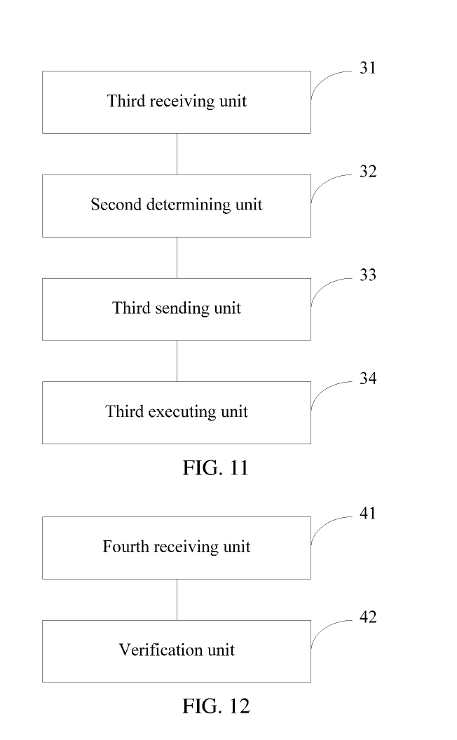

Referring to FIG. 11, FIG. 11 is a structural diagram of Embodiment 3 of an apparatus for on-boarding a network service descriptor NSD disclosed in the present disclosure. The apparatus may be a primary orchestrator, may be specifically an NFVO or an NSO, and specifically includes the following units:

a third receiving unit 31, configured to receive a cross-domain network service descriptor NSD on-boarding command from a sender;

a second determining unit 32, configured to: determine, according to the cross-domain NSD on-boarding command, that the primary orchestrator needs to on-board an NSD, and in a process of on-boarding the NSD by the primary orchestrator, determine, according to the cross-domain NSD on-boarding command, that a secondary orchestrator needs to verify VNF packet information corresponding to a management domain of the secondary orchestrator;

a third sending unit 33, configured to send a verification command to the secondary orchestrator, where the verification command is used to instruct the secondary orchestrator to verify whether the VNF packet information is available, and the verification command includes the VNF packet information corresponding to the management domain of the secondary orchestrator, wherein

the third receiving unit is further configured to receive a notification message indicating that the VNF packet information is available, where the notification message is fed back when the secondary orchestrator verifies that the VNF packet information is available; and

a third executing unit 34, configured to on-board the NSD.

It should be noted that, the cross-domain NSD on-boarding command carries NSD information for describing a network service NS and VNF packet information, and the second determining unit is specifically configured to:

determine, according to the cross-domain NSD on-boarding command, the NSD information and the VNF packet information corresponding to a management domain of the primary orchestrator that are used to describe the NS.

The third sending unit is specifically configured to:

send, to the secondary orchestrator, the verification command carrying a VNF packet identifier corresponding to the management domain of the secondary orchestrator, where the verification command carrying the VNF packet identifier corresponding to the management domain of the secondary orchestrator is used to instruct the secondary orchestrator to verify, according to the VNF packet identifier corresponding to the management domain of the secondary orchestrator, whether a VNF packet and an external interface in the management domain of the secondary orchestrator are available.

The third receiving unit is specifically configured to receive a notification message indicating that the VNF packet information is available, where the notification message is fed back when the secondary orchestrator verifies that the VNF packet and the external interface in the management domain of the secondary orchestrator are available; or receive a verification reply command indicating that the VNF packet information is unavailable, where the verification reply command is fed back when the secondary orchestrator verifies that the VNF packet and the external interface in the management domain of the secondary orchestrator are unavailable.

The third receiving unit is further configured to:

receive a VNF packet on-board acknowledge command that carries a success indication and that is fed back by the secondary orchestrator; and

the third sending unit is specifically configured to: after the NSD corresponding to the management domain of the primary orchestrator is on-boarded, send a cross-domain NSD on-boarding complete notification message to the sender.

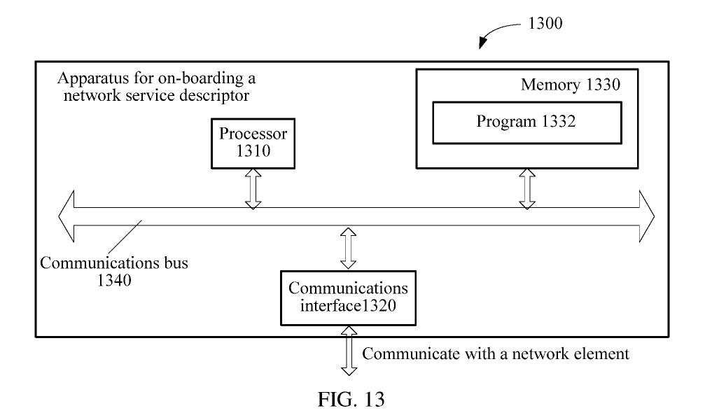

Referring to FIG. 12, FIG. 12 is a structural diagram of Embodiment 4 of an apparatus for on-boarding a network service descriptor NSD disclosed in the present disclosure. The apparatus may be a secondary orchestrator, may be specifically an NFVO or an NSO, and specifically includes the following units:

a fourth receiving unit 41, configured to receive a verification command sent by a primary orchestrator, where the verification command is used to instruct the secondary orchestrator to verify whether VNF packet information is available, and the verification command includes the VNF packet information corresponding to a management domain of the secondary orchestrator; and

a verification unit 42, configured to verify, according to the verification command, whether the VNF packet information is available, where

when it is verified that the VNF packet information is available, a notification message indicating that the VNF packet information is available is fed back to the primary orchestrator.

It should be noted that, the verification command carries a VNF packet identifier corresponding to the management domain of the secondary orchestrator, and the verification unit is specifically configured to:

verify, according to the VNF packet identifier corresponding to the management domain of the secondary orchestrator, whether a VNF packet and an external interface in the management domain of the secondary orchestrator are available; and

when the VNF packet and the external interface are available, trigger a fourth sending unit to feed back a notification message indicating that the VNF packet information is available to the primary orchestrator; or

when the VNF packet and the external interface are unavailable, trigger a fourth executing unit to on-board a VNF packet corresponding to the management domain of the secondary orchestrator.

A fourth executing unit is specifically configured to:

feed back a verification reply command to the primary orchestrator, where the verification reply command carries identifier information about one or more VNF packets that are unavailable in the management domain of the secondary orchestrator;

receive a VNF packet on-boarding command from the primary orchestrator, where the VNF packet on-boarding command includes identifier information about a VNF packet needing to be on-boarded and metadata information about the VNF packet, the metadata information about the VNF packet including one or more of a VNF descriptor, VNF software image information, or VNF software version information; and

on-board, according to the VNF packet on-boarding command, the VNF packet in the management domain of the secondary orchestrator.

A fourth sending unit is further configured to feed back, to the primary orchestrator, a VNF packet on-board acknowledge command carrying a success indication.

It should further be noted that, specific function implementation of each unit in the apparatus embodiments (that is, embodiments corresponding to FIG. 9 to FIG. 12) is described in detail in the method embodiments (that is, embodiments corresponding to FIG. 3 to FIG. 8), and details are not described herein again.

In addition, an embodiment of this application further provides an apparatus for on-boarding a network service descriptor. FIG. 13 is a structural diagram of an apparatus for on-boarding a network service descriptor according to this application. As shown in FIG. 13, the apparatus 1300 for on-boarding a network service descriptor includes:

a processor 1310, a communications interface 1320, a memory 1330, and a bus 1340.

The processor 1310, the communications interface 1320, and the memory 1330 communicate with each other by using the bus 1340.

The processor 1310 is configured to execute a program 1332.

Specifically, the program 1332 may include program code, and the program code includes a computer operation instruction.

The processor 1310 may be a central processing unit (CPU), or an application-specific integrated circuit (ASIC), or one or more integrated circuits configured to implement the embodiments of this application.

The memory 1330 is configured to store the program 1332. The memory 1330 may include a high-speed RAM memory, and may further include a non-volatile memory, such as at least one magnetic disk memory. An instruction stored in the memory 1330 may enable the processor 1310 to perform the method in Embodiments 1 to 4.

Optionally, the apparatus for on-boarding a network service descriptor may be a primary orchestrator. The instruction stored in the memory 1330 may enable the processor 1310 to perform the following operations:

obtaining, by using the communications interface 1320, a cross-domain network service descriptor NSD on-boarding command sent by a sender;

determining, according to the cross-domain NSD on-boarding command, that a secondary orchestrator needs to on-board an NSD corresponding to a management domain of the secondary orchestrator; and

sending an NSD on-boarding command to the secondary orchestrator by using the communications interface 1320, where the NSD on-boarding command is used to instruct the secondary orchestrator to on-board the NSD corresponding to the management domain of the secondary orchestrator, where

the apparatus for on-boarding a network service descriptor and the secondary orchestrator have different management domains respectively.

Optionally, the apparatus for on-boarding a network service descriptor may be a secondary orchestrator. The instruction stored in the memory 1330 may enable the processor 1310 to perform the following operations:

obtaining, by using the communications interface 1320, an NSD on-boarding command sent by a primary orchestrator, where the NSD on-boarding command is used to instruct the secondary orchestrator to on-board an NSD corresponding to a management domain of the secondary orchestrator; and

on-boarding, according to the NSD on-boarding command, the NSD corresponding to the management domain of the secondary orchestrator.

Optionally, the apparatus for on-boarding a network service descriptor may be a primary orchestrator. The instruction stored in the memory 1330 may enable the processor 1310 to perform the following operations:

obtaining, by using the communications interface 1320, a cross-domain network service descriptor NSD on-boarding command sent by a sender;

determining, according to the cross-domain NSD on-boarding command, that the primary orchestrator needs to on-board an NSD;

in a process of on-boarding the NSD by the primary orchestrator, determining, according to the cross-domain NSD on-boarding command, that a secondary orchestrator needs to verify VNF packet information corresponding to a management domain of the secondary orchestrator;

sending a verification command to the secondary orchestrator by using the communications interface 1320, where the verification command is used to instruct the secondary orchestrator to verify whether the VNF packet information corresponding to the management domain of the secondary orchestrator is available, and the verification command includes the VNF packet information.

receiving, by using the communications interface 1320, a notification message indicating that the VNF packet information is available, where the notification message is fed back when the secondary orchestrator verifies that the VNF packet information is available.

Optionally, the apparatus for on-boarding a network service descriptor may be a secondary orchestrator. The instruction stored in the memory 1330 may enable the processor 1310 to perform the following operations:

obtaining, by using the communications interface 1320, a verification command sent by a primary orchestrator, where the verification command is used to instruct the secondary orchestrator to verify whether VNF packet information corresponding to a management domain of the secondary orchestrator is available, and the verification command includes the VNF packet information corresponding to the management domain of the secondary orchestrator;

verifying, according to the verification command, whether the VNF packet information is available; and

when it is verified that the VNF packet information is available, feeding back, by using the communications interface 1320, a notification message indicating that the VNF packet information is available.

The embodiments in this specification are all described in a progressive manner, for same or similar parts in the embodiments, refer to these embodiments, and each embodiment focuses on a difference from other embodiments. The apparatus disclosed in the embodiments is described relatively simply because it corresponds to the method disclosed in the embodiments, and for portions related to those of the method, refer to the description of the method.

A person skilled in the art may further be aware that, in combination with the examples described in the embodiments disclosed in this specification, units and algorithm steps may be implemented by electronic hardware or a combination of computer software and electronic hardware. To clearly describe the interchangeability between the hardware and the software, the foregoing has generally described compositions and steps of each example according to functions. Whether the functions are performed by hardware or software and hardware depends on particular applications and design constraint conditions of the technical solutions. A person skilled in the art may use different methods to implement the described functions for each particular application, but it should not be considered that the implementation goes beyond the scope of the present disclosure.

In combination with the embodiments disclosed in this specification, method or algorithm steps may be implemented by hardware, a software module executed by a processor, or a combination thereof. The software module may reside in a random access memory, a memory, a read-only memory, an electrically programmable (ROM), an electrically erasable programmable (ROM) , a register, a hard disk, a removable disk, a CD-ROM, or any other form of storage medium known in the art.

The embodiments disclosed above are described to enable a person skilled in the art to implement or use the present disclosure. Various modifications to the embodiments are obvious to the person skilled in the art, and general principles defined in this specification may be implemented in other embodiments without departing from the scope of the present disclosure. Therefore, the present disclosure will not be limited to the embodiments described in this specification but extends to the widest scope that complies with the principles and novelty disclosed in this specification.

What is claimed is:

1. A method for on-boarding a network service descriptor, the method comprising:
receiving, by a primary orchestrator, a cross-domain network service descriptor (NSD) on-boarding command from a sender;
determining, by the primary orchestrator according to the cross-domain NSD on-boarding command, that a secondary orchestrator needs to on-board an NSD corresponding to a management domain of the secondary orchestrator;
sending, by the primary orchestrator, an NSD on-boarding command to the secondary orchestrator for instructing the secondary orchestrator to on-board the NSD corresponding to the management domain of the secondary orchestrator; and
wherein a management domain of the primary orchestrator is different from the management domain of the secondary orchestrator.

2. The method according to claim 1, further comprising:
determining, by the primary orchestrator according to the cross-domain NSD on-boarding command, that the primary orchestrator needs to on-board an NSD corresponding to the management domain of the primary orchestrator.

3. The method according to claim 2, wherein:
the cross-domain NSD on-boarding command carries NSD information for describing a network service (NS) and virtualized network function (VNF) packet information; and
determining, by the primary orchestrator, that the primary orchestrator needs to on-board the NSD comprises:
determining, by the primary orchestrator according to the cross-domain NSD on-boarding command, the NSD information and the VNF packet information corresponding to the management domain of the primary orchestrator.

4. The method according to claim 1, wherein:
determining, by the primary orchestrator, that the secondary orchestrator needs to on-board the NSD comprises:
determining, by the primary orchestrator according to the cross-domain NSD on-boarding command, NSD information and virtualized network function (VNF) packet information that correspond to the management domain of the secondary orchestrator; and
sending the NSD on-boarding command to the secondary orchestrator comprises:
sending, by the primary orchestrator to the secondary orchestrator, the NSD on-boarding command carrying the NSD information and the VNF packet information that correspond to the management domain of the secondary orchestrator.

5. The method according to claim 4, wherein determining, by the primary orchestrator, the NSD information and the VNF packet comprises:
determining, by the primary orchestrator according to the cross-domain NSD on-boarding command, an NSD identifier that corresponds to the management domain of the secondary orchestrator.

6. The method according to claim 4, wherein determining, by the primary orchestrator, the NSD information and the VNF packet comprises:
determining, by the primary orchestrator according to the cross-domain NSD on-boarding command, a VNF packet identifier that corresponds to the management domain of the secondary orchestrator.

7. The method according to claim 4, wherein determining, by the primary orchestrator, the NSD information and the VNF packet comprises:
determining, by the primary orchestrator according to the cross-domain NSD on-boarding command, at least one of: an NSD identifier for describing a network service (NS), an identifier of the primary orchestrator, a correspondence between an identifier for describing a VNF packet of the NS and the identifier of the primary orchestrator, or a correspondence between the identifier for describing the VNF packet of the NS and an identifier of the secondary orchestrator.

8. The method according to claim 1, further comprising:
receiving, by the primary orchestrator, an NSD on-boarding complete notification message from the secondary orchestrator; and
sending, by the primary orchestrator, a cross-domain NSD on-boarding complete notification message to the sender after an NSD corresponding to the management domain of the primary orchestrator is on-boarded.

9. The method according to claim 1, wherein:
the primary orchestrator is a network function virtualization orchestrator or a network service orchestrator; and
the secondary orchestrator is a network function virtualization orchestrator or a network service orchestrator.

10. An apparatus, comprising:
at least one processor, a communication interface, and a non-transitory computer readable storage medium storing a program which, when executed by the at least one processor, cause the apparatus to:
utilize the communication interface to receive a cross-domain network service descriptor (NSD) on-boarding command from a sender,
determine, according to the cross-domain NSD on-boarding command, that a secondary orchestrator needs to on-board an NSD corresponding to a management domain of the secondary orchestrator, and
utilize the communication interface to send an NSD on-boarding command to the secondary orchestrator for instructing the secondary orchestrator to on-board the NSD corresponding to the management domain of the secondary orchestrator; and
wherein a management domain of a primary orchestrator is different from the management domain of the secondary orchestrator.

11. The apparatus according to claim 10, wherein the program, when executed by the at least one processor, further causes the apparatus to:
determine, according to the cross-domain NSD on-boarding command, that the primary orchestrator needs to on-board an NSD corresponding to the management domain of the primary orchestrator.

12. The apparatus according to claim 11, wherein:
the cross-domain NSD on-boarding command carries NSD information for describing a network service (NS) and virtualized network function (VNF) packet information; and
to determine that the primary orchestrator needs to on-board the NSD, the program, when executed by the at least one processor, causes the apparatus to:
determine according to the cross-domain NSD on-boarding command, the NSD information and the VNF packet information corresponding to the management domain of the primary orchestrator.

13. The apparatus according to claim 10, wherein:
to determine that the secondary orchestrator needs to on-board the NSD, the program, when executed by the at least one processor, causes the apparatus to:
determine, according to the cross-domain NSD on-boarding command, NSD information and virtualized network function (VNF) packet information that correspond to the management domain of the secondary orchestrator; and
to utilize the communication interface to send the NSD on-boarding command to the secondary orchestrator, the program, when executed by the at least one processor, causes the apparatus to:
send, to the secondary orchestrator, the NSD on-boarding command carrying the NSD information and the VNF packet information that correspond to the management domain of the secondary orchestrator.

14. The apparatus according to claim 13, wherein to determine the NSD information and the VNF packet information, the program, when executed by the at least one processor, causes the apparatus to:
determine, according to the cross-domain NSD on-boarding command, an NSD identifier that corresponds to the management domain of the secondary orchestrator.

15. The apparatus according to claim 13, wherein to determine the NSD information and the VNF packet information, the program, when executed by the at least one processor, causes the apparatus to:
determine, according to the cross-domain NSD on-boarding command, a VNF packet identifier that corresponds to the management domain of the secondary orchestrator.

16. The apparatus according to claim 13, wherein to determine the NSD information and the VNF packet information, the program, when executed by the at least one processor, causes the apparatus to:
determine, according to the cross-domain NSD on-boarding command, an NSD identifier for describing a network service (NS), at least one of: an identifier of the primary orchestrator, a correspondence between an identifier for describing a VNF packet of the NS and the identifier of the primary orchestrator, or a correspondence between the identifier for describing the VNF packet of the NS and an identifier of the secondary orchestrator.

17. The apparatus according to claim 10, wherein the program, when executed by the at least one processor, causes the apparatus to:
receive, an NSD on-boarding complete notification message from the secondary orchestrator; and
send, a cross-domain NSD on-boarding complete notification message to the sender after an NSD corresponding to the management domain of the primary orchestrator is on-boarded.

18. The apparatus according to claim 10, wherein:
the primary orchestrator is a network function virtualization orchestrator or a network service orchestrator; and
the secondary orchestrator is a network function virtualization orchestrator or a network service orchestrator.

19. A non-transitory computer readable storage medium storing a program to be executed by at least one processor, the program comprising instructions for:
receiving a cross-domain network service descriptor (NSD) on-boarding command from a sender;
determining, according to the cross-domain NSD on-boarding command, that a secondary orchestrator needs to on-board an NSD corresponding to a management domain of the secondary orchestrator;
sending an NSD on-boarding command to the secondary orchestrator for instructing the secondary orchestrator to on-board the NSD corresponding to the management domain of the secondary orchestrator; and
wherein a management domain of a primary orchestrator is different from the management domain of the secondary orchestrator.

20. The non-transitory computer readable storage medium according to claim 19, wherein the program further comprises instructions for:
determining, according to the cross-domain NSD on-boarding command, that the primary orchestrator needs to on-board an NSD corresponding to the management domain of the primary orchestrator.
